(19) United States
(12) Patent Application Publication
(10) Pub. No.: US 2008/0241784 A1
(43) Pub. Date: Oct. 2, 2008

(54) Distance Measuring Apparatus for Dental Implant Insertion

(76) Inventor: Yoo-Jin Chung, Seoul (KR)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/064,157

(22) PCT Filed: Aug. 11, 2006
(86) PCT No.: PCT/KR2006/003154

§ 371 Date: Feb. 19, 2008

(30) Foreign Application Priority Data
Aug. 19, 2005 (KR) 10-2005-0076188
Jul. 12, 2006 (KR) 10-2006-0065356

(51) Int. Cl. A61C 3/02

(52) U.S. Cl. 433/76

(57) ABSTRACT

Provided is a distance measuring apparatus for dental implant insertion which has a support frame and a guide frame integrally formed to be bent from the upper part of the support frame and having a plurality of guide holes therein for determining drilling points. According to the distance measuring apparatus for dental implant insertion, a proper determination of drilling points becomes possible without a surgical stent and as well the drilling points can be properly changed when an implant cannot be inserted at an originally planned portion due to an alveolus resorption even in the case of using the surgical stent.

### TECHNICAL FIELD

The present invention relates to a distance measuring apparatus for dental implant insertion, and more particularly to a distance measuring apparatus for dental implant insertion comprising a support frame and a guide frame integrally formed to be bent from the upper part of the support frame and having a plurality of guide holes therein for determining drilling points.

### BACKGROUND ART

An implant operation is a method wherein an artificial tooth-root made of titanium is implanted into a jawbone in the part where a tooth falls out so that the tooth-root is osseointegrated with the jawbone and fixed.

In the art, when a tooth falls out, both teeth near the falling-out tooth are usually ground out so that a dental prosthesis corresponding to those three teeth is placed thereto. Further, when several teeth fall out, a set of false teeth is usually placed thereto. However, such methods were very inconvenient in many aspects.

Therefore, there have been many researches on methods for recovering a falling-out tooth to the extent that it can be used as like one's original tooth. After discovering a good osseointegration of titanium with a bone, an implant operation has been developed, in which a fixture of titanium treated in a special way is implanted into a jawbone in the part where a tooth falled out and a dental prosthesis shaped of a tooth is combined thereto so that the dental prosthesis can be used as like one's original tooth in terms of appearance and function. In the method, an alveolus is drilled to form a hole and a screw-shaped artificial root made of titanium biometal is inserted into the hole. After three months the alveolus and the artificial root are oesseointegrated with each other and then an artificial tooth is combined to the artificial root.

An outstanding effect had been obtained with the development of the implant operation, and as well the implant operation has been further developed. That is, contrary to the prior method wherein an implant is inserted three months after the deteriorated tooth is removed, in order to shorten the healing term, there has been made efforts such as implanting immediately after removing a tooth or combining an artificial tooth two months later after the insertion of the implant.

Meanwhile, in the art, the tooth-removed part is first patterned, and a surgical stent (a personally adapted device for determining an insertion position of an implant) is made to determine the insertion position of the implant. That is, a conventional distance measuring apparatus for implant insertion has usually a fixed type so that the insertion position is roughly determined according to operator's experience and decision and to this end a hole for the insertion should be formed. However, such conventional distance measuring method has a limitation resulting from different mouth structures in human and has a problem that the implant is inserted inaccurately in its direction and angle upon the insertion because of the difficulty to measure a proper distance in the portion adjacent to the tooth resulting from the sight hindrance of the tooth.

### DISCLOSURE OF INVENTION

### Technical Problem

The present invention is made to solve the above problems, and an object of the invention is to provide a distance measuring apparatus for dental implant insertion wherein a plurality of guide holes are formed on a guide frame integrally formed with a support frame so that a proper determination of drilling points becomes possible without a surgical stent and as well the drilling points can be properly changed when an implant cannot be inserted at an originally planned part due to an alveolus resorption even in the case of using the surgical stent.

Another object of the present invention is to provide a distance measuring apparatus for dental implant insertion wherein the guide frame comprises a graduated ruler on any one side of the guide frame so that an error of the drilling points caused from a shape of a distal surface (a rear contact surface; hereinafter referred as “distal surface) of tooth or an affection by an alveolus and the like can be checked.

Another object of the present invention is to provide a distance measuring apparatus for dental implant insertion wherein a first drilling hole is formed in one side of a drilling guide frame which is integrally formed with a support frame, and a second drilling hole is formed separately from the first drilling hole at the other side of the drilling guide frame so that the continuous drilling points can be determined corresponding to the distance between the first drilling hole and the second drilling hole.

Another object of the present invention is to provide a distance measuring apparatus for dental implant insertion wherein stepped reference points are formed on a side of a drilling guide frame where a second drilling hole is formed so that it is not necessary to manually measure scales of a drill with a graduated ruler one by one in an operation.

Another object of the present invention is to provide a distance measuring apparatus for dental implant insertion wherein the some parts of a support frame is rotatably connected by means of a hinge so that the support frame can be inserted into a mouth while being properly modified and to this end the precise distance measurement and the insertion of a dental implant can be carried out.

### Technical Solution

In order to accomplish the above and other objects, there is provided a distance measuring apparatus for dental implant insertion comprising: a support frame; and a guide frame formed to be bent from one side of the support frame and having one or more guide holes for determining drilling points.

According to an embodiment of the invention, it is preferred that the guide hole is formed with its center positioning 3˜4.5 mm apart from an inner side surface of the guide frame.

According to an embodiment of the invention, it is preferred that the guide hole has a diameter of 1˜2.5 mm through which an implant drill passes.

According to an embodiment of the invention, it is preferred that the guide frame is provided with a graduated ruler at its outer side surface edge.

According to an embodiment of the invention, it is preferred that the support frame is provided with a drilling guide frame at the other side of the support frame and the drilling guide frame include a first drilling guide hole at the one side of the drilling guide frame and a second drilling hole spaced from the first drilling hole in a direction of the other side of the drilling guide frame.

According to an embodiment of the invention, it is preferred that the drilling guide frame is provided at its outer side with a reference point consisting of stepped stages, through which a length of the implant drill is measured.

According to an embodiment of the invention, it is preferred that the support frame is provided with one or more hinges at some parts of the support frame and the support frame is bent centering the hinge.

According to an embodiment of the invention, it is preferred that the support frame is provided with one or more hinges at some parts of the support frame and the support frame is bent at the middle of its length centering the hinge.

According to an embodiment of the invention, it is preferred that the drilling guide frame is provided with a third drilling hole on the line between the first drilling hole and the second drilling hole.

According to an embodiment of the invention, it is preferred that the first drilling hole is a circular hole, and the second and third drilling holes are semi-circular open holes formed on an edge of the drilling guide frame.

According to an embodiment of the invention, it is preferred that scales are formed from the first drilling hole to the third drilling hole.

According to an embodiment of the invention, it is preferred that the guide frame is provided with a slider moving in a lengthwise direction of the guide frame, and the slider has a slot through which the guide frame is inserted, and a bolt is fastened from an outer side of the slider to the inside of the slot in order to press the guide frame, and a support extends from the slider in a direction of the inner side of the guide frame.

According to an embodiment of the invention, it is preferred that the guide frame is provided with a groove along its lengthwise direction and the bolt is inserted into the groove to press and fix the guide frame.

### ADVANTAGEOUS EFFECTS

According to the present invention, there is an effect that a proper determination of drilling points becomes possible without a surgical stent and as well the drilling points can be properly changed when an implant cannot be inserted at an originally planned portion due to an alveolus resorption even in the case of using the surgical stent by means of formation of a plurality of guide holes in a guide frame integrally formed with a support frame.

Another effect of the present invention is that an error of the drilling points caused from a shape of a distal surface of tooth or an affection by an alveolus and the like can be checked by means of comprising a graduated ruler on an outer side edge of the guide frame.

Another effect of the present invention is that the continuous drilling points can be determined by the constitution that a first drilling hole is formed in one side of a drilling guide frame which is integrally formed with a support frame, and a second drilling hole is formed separately from the first drilling hole at the other side of the drilling guide frame.

Another effect of the present invention is that it is not necessary to manually measure scales of a drill with a graduated ruler one by one in an operation by means of forming stepped reference points on a side of a drilling guide frame where a second drilling hole is formed.

Another effect of the present invention is that the support frame can be inserted into a mouth while being properly modified and to this end the precise distance measurement and the insertion of the dental implant can be carried out by means of rotatably connecting pieces of the support frame with hinge.

### BRIEF DESCRIPTION OF THE DRAWINGS

FIG. 1 is a view illustrating the constitution of a distance measuring apparatus for dental implant insertion according to a first example of the invention.

FIGS. 2 and 3 are views illustrating the utilization condition of determining a drilling point using the distance measuring apparatus for dental implant insertion as illustrated in FIG. 1.

FIG. 4 is a view illustrating the constitution of a distance measuring apparatus for dental implant insertion according to a second example of the invention.

FIG. 5 is a view illustrating the utilization condition of measuring a width of an alveolus using the distance measuring apparatus for dental implant insertion as illustrated in FIG. 4.

FIG. 6 is a view illustrating the utilization condition of determining continuous drilling points using the distance measuring apparatus for dental implant insertion as illustrated in FIGS. 1 and 4.

FIG. 7 is a view illustrating the constitution of a distance measuring apparatus for dental implant insertion according to a third example of the invention.

FIG. 8 is a detailed view illustrating a drilling guide frame as illustrated in FIG. 7.

FIG. 9 is a view illustrating the utilization condition of measuring a length of a drill using the distance measuring apparatus for dental implant insertion as illustrated in FIG. 7.

FIG. 10 is a view illustrating the utilization condition of determining continuous implant insertion hole using the distance measuring apparatus for dental implant insertion as illustrated in FIG. 7.

FIG. 11 is a view illustrating the condition that an implant is inserted into a gum and an artificial tooth is mounted thereon.

FIG. 12 is a front view of a guide pin included in a conventional implant operation set.

FIG. 13 is a view illustrating the constitution of a distance measuring apparatus for dental implant insertion according to a fourth example of the invention.

FIG. 14 is a view illustrating the utilization condition of the distance measuring apparatus for dental implant insertion as illustrated in FIG. 13.

FIG. 15 is a view illustrating the constitution of a distance measuring apparatus for dental implant insertion according to a fifth example of the invention.

FIG. 16 is a view illustrating the utilization condition of the distance measuring apparatus for dental implant insertion as illustrated in FIG. 15.

FIG. 17 is a view illustrating the constitution of a distance measuring apparatus for dental implant insertion according to a sixth example of the invention.

FIG. 18 is a sectional view of the distance measuring apparatus for dental implant insertion as illustrated in FIG. 17.

FIG. 19 is a view illustrating the utilization condition of the distance measuring apparatus for dental implant insertion as illustrated in FIG. 17.

### DESCRIPTION OF THE NUMERALS OF THE MAIN PARTS OF FIGURES

100: support frame
100: first hinge
120: second hinge
200: guide frame
210: guide hole
220: graduated ruler
230: slider
237: support
300: drilling guide frame
310: first drilling hole
320: second drilling hole
330: reference point
400: gum
410: tooth
410a: artificial tooth
420, 421: implant insertion hole
430: implant
500: implant drill
600: guide pin

### Mode for the Invention

Hereinafter, the preferred examples of the present invention will be described in detail with reference to the accompanying figures.

### EXAMPLE 1

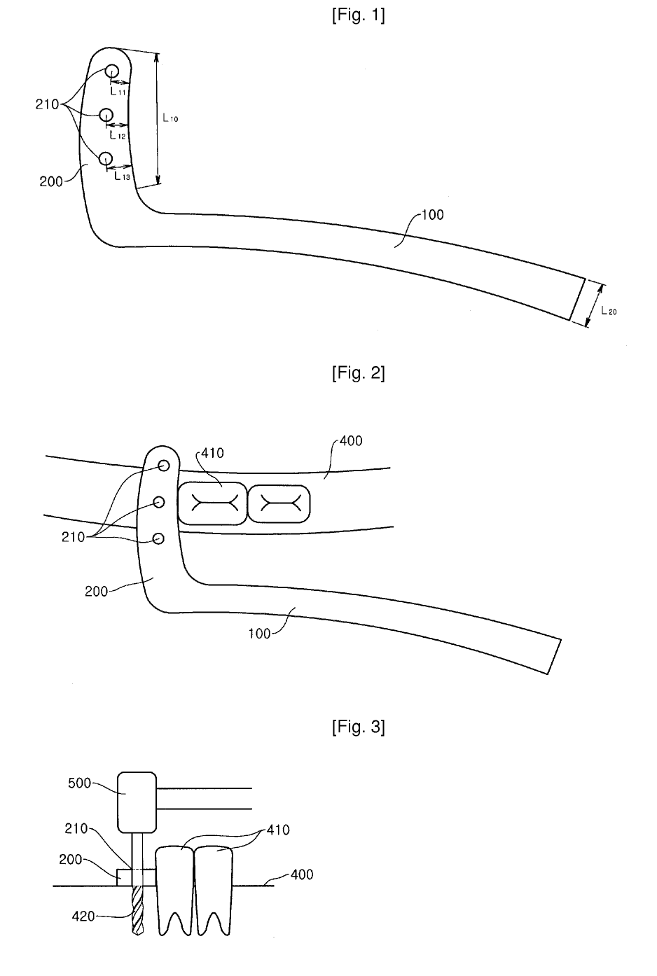

FIG. 1 is a view illustrating the constitution of a distance measuring apparatus for dental implant insertion according to a first example of the invention. FIGS. 2 and 3 are views illustrating the utilization condition of determining a drilling point using the distance measuring apparatus for dental implant insertion as illustrated in FIG. 1.

The distance measuring apparatus for dental implant insertion according to the first example, as illustrated in FIG. 1, comprises a support frame 100 serving as a grip having a form of a gently-sloping curve and a guide frame 200 formed to be bent from one side of the support frame 100.

Further, the other end side of the support frame 100 has a width L20 of 7˜8 mm, which makes it possible to easily determine a distance between implants in case that two or more implants 430 are continuously inserted as illustrated in FIG. 6. The distance between the implants is in general 7˜8 mm.

The guide frame 200 is provided at its plane with three guide holes 210, which are used for determining a drilling point. A length L10 of an inner side surface of the guide frame 200 contacting a tooth 410 is 15 mm, and the inner side of the guide frame 200 is preferably formed to have a gently-sloping curve, i.e., a concaved curve.

As illustrated in FIG. 3, the guide hole 210 is formed to have the same diameter as that of an implant drill 500. Thus, by passing the implant drill 500 through the guide hole 210, an implant insertion hole 420 can be easily formed. The implant drill 500 has a diameter of 1˜2.5 mm in general so that the guide hole 210 preferably has the same diameter of 1˜2.5 mm as that of the implant drill 500.

The guide frame 200 has three guide holes 210, the centers of which are spaced from the inner curved surface of the guide frame 200 to have distances L11, L12, and L13 of 3 mm, 3.5 mm, and 4 mm, respectively.

Meanwhile, contrary to the above distances, the distances L11, L12, and L13 from the inner curved surface of the guide frame 200 to the centers of the guide holes 210 can be made to be 3.5 mm, 4 mm, and 4.5 mm, respectively. Since such distances are set according to a typical tooth size of an adult, it may be set in a range from minimum 3 mm to maximum 4.5 mm.

Meanwhile, upon insertion of the implant 430, it is difficult to measure a precise distance in the adjacent portion of the tooth 410 due to a sight hindrance of the tooth 410. Thus, as illustrated in FIG. 2, it is possible to properly determine a drilling point using the distance measuring apparatus for dental implant insertion according to the invention.

It is preferred that the support frame 100 is composed of a high temperature and pressure sterilizable metal or a disposable transparent plastic material.

### EXAMPLE 2

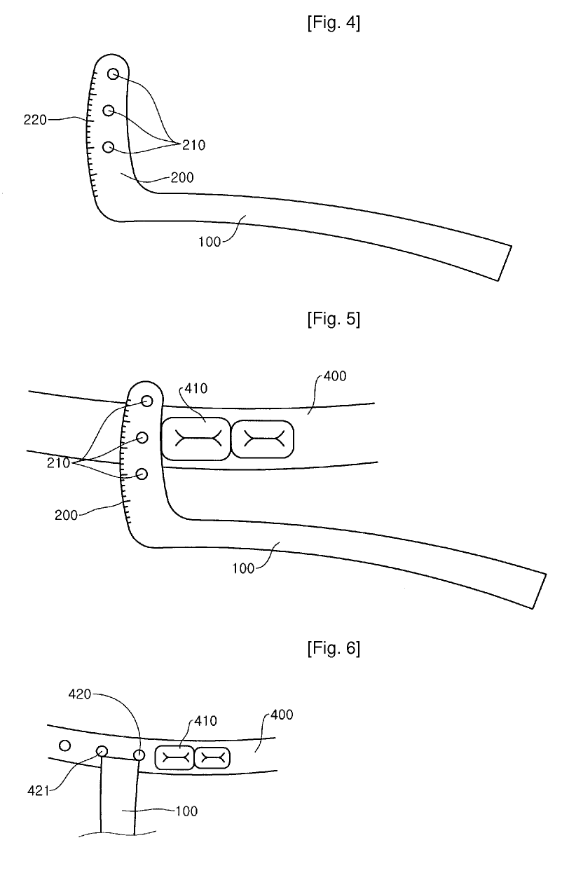

FIG. 4 is a view illustrating the constitution of a distance measuring apparatus for dental implant insertion according to a second example of the invention. FIG. 5 is a view illustrating the utilization condition of measuring a width of an alveolus using the distance measuring apparatus for dental implant insertion as illustrated in FIG. 4. FIG. 6 is a view illustrating the utilization condition of determining continuous drilling points using the distance measuring apparatus for dental implant insertion as illustrated in FIGS. 1 and 4.

As compared to the first example, the distance measuring apparatus for dental implant insertion according to the second example has the same constitution as that of the first example, excluding that scales are additionally imprinted on an outer edge of the guide frame 200, which can serve as a graduated ruler. Therefore, the detailed explanation for the specific elements explained already in the first example would be omitted and instead the same elements as that of the first example are designated to have the same numerals as that of the first example.

As illustrated in FIGS. 4 and 5, the distance measuring apparatus for dental implant insertion according to the second example comprises a support frame 100 having a form of a gently-sloping curve and a guide frame 200 integrally formed with the support frame 100 to be bent from one side of the support frame 100. A graduated ruler 220 is formed on the outer edge of the guide frame 200 to measure a width of an alveolus. Preferably, the graduated ruler 220 is formed on both sides of the guide frame 200.

### EXAMPLE 3

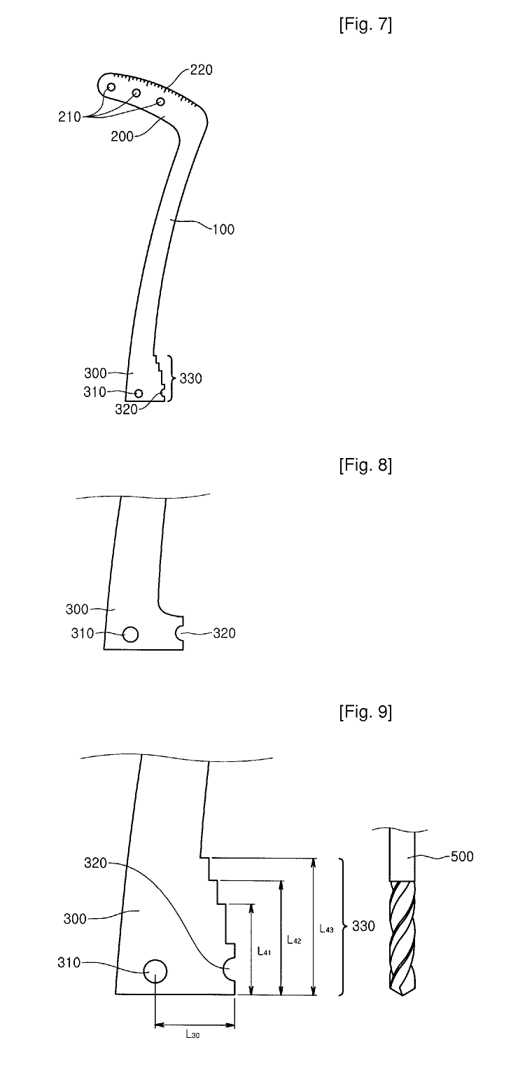

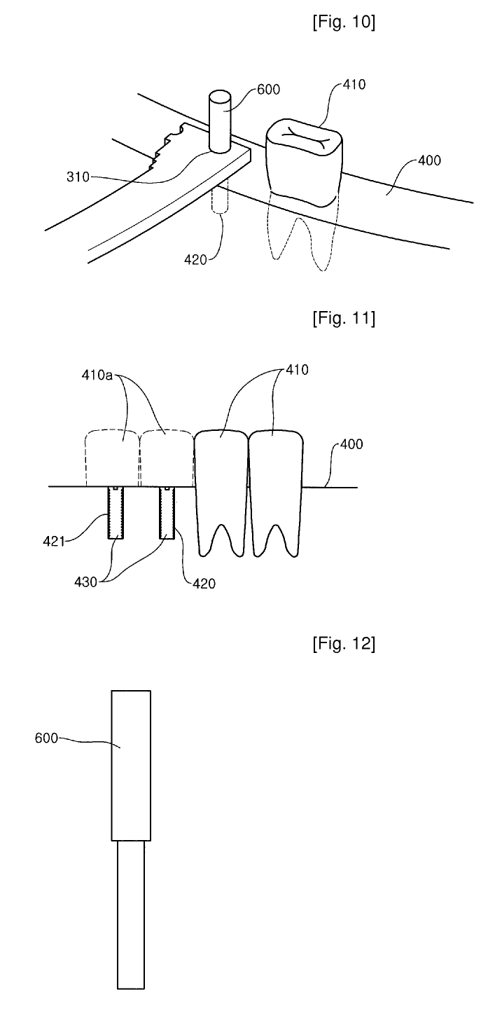

FIG. 7 is a view illustrating the constitution of a distance measuring apparatus for dental implant insertion according to a third example of the invention. FIG. 8 is a detailed view illustrating a drilling guide frame as illustrated in FIG. 7. FIG. 9 is a view illustrating the utilization condition of measuring a length of a drill using the distance measuring apparatus for dental implant insertion as illustrated in FIG. 7. FIG. 10 is a view illustrating the utilization condition of determining continuous implant insertion hole using the distance measuring apparatus for dental implant insertion as illustrated in FIG. 7. FIG. 11 is a view illustrating the condition that an implant is inserted into a gum and an artificial tooth is mounted thereon. FIG. 12 is a front view of a guide pin included in a conventional implant operation set.

As compared to the second example, the distance measuring apparatus for dental implant insertion according to the third example further comprises a drilling guide frame 300 at the other end side of the support frame 100. The constitution of the drilling guide frame 300 will be specifically described hereinafter. Further, the description about the elements explained already in the second example would be omitted.

As illustrated in FIG. 7, the distance measuring apparatus for dental implant insertion according to the third example comprises a support frame 100 having a form of a gently-sloping curve, a guide frame 200 integrally formed with the support frame 100 to be bent from one side of the support frame 100 with a graduated ruler 220 on the outer edge of the support frame 100, and a drilling guide frame 300 for determining an insertion position of continuous implants 430 and measuring a length of the implant drill 500.

As illustrated in FIGS. 8 and 10, the drilling guide frame 300 is provided with a first drilling hole 310 on its one inner side and a second drilling hole 320 is also formed to be spaced apart from the first drilling hole 310 on the other side of the drilling guide frame 300.

The first and second drilling holes 310 and 320 have the same diameters of 2 mm as those of the guide holes 210, and a distance L30 between the first and second drilling holes 310 and 320 is 7˜8 mm, which is the same as that of the general implants upon insertion of continuous implants.

Meanwhile, as set forth before, the diameter of 2 mm and the distance of 7˜8 mm in the first and second drilling holes 310 and 320 are merely preferable examples. The diameter can be adjusted within the range of 1˜2.5 mm depending upon the case and the distance can also be made to be wider or narrower.

The guide pin 600 is a guide pin in all conventional implant operation set, and as illustrated in FIG. 12, it is preferably formed to have an upper diameter of 3 mm and a lower diameter of 2 mm.

Meanwhile, as illustrated in FIG. 9, the drilling guide frame 300 is provided at its side with a stepped reference point 330 for measuring a length of the implant drill 500.

The stepped reference point 330 has a three-stage structure in which the distances L41, L42, and L43 from the end side to the respective steps are 8 mm, 10 mm, and 12 mm, respectively.

The above reference point 330 serves as a kind of graduated ruler for easily measuring a length of the implant drill 500 in an operation. The length of general implant drill 500 is 8 mm, 10 mm, and 12 mm.

Herein, the values of the distances L41, L42, and L43 from the end side to respective steps are merely the preferred examples, and therefore the constitution of the reference point is not limited thereto.

### EXAMPLE 4

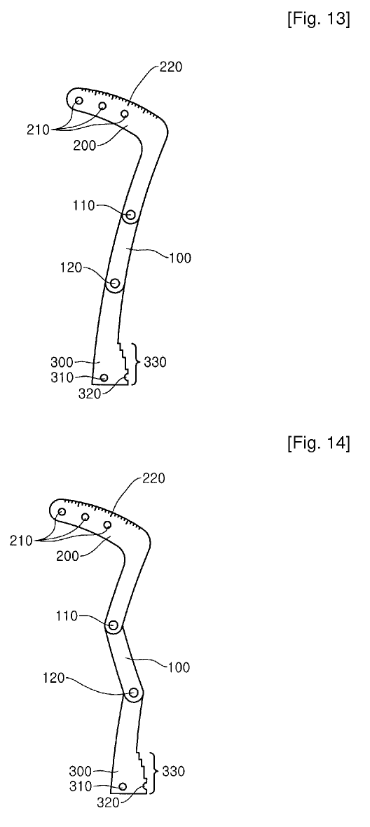

FIG. 13 is a view illustrating the constitution of a distance measuring apparatus for dental implant insertion according to a fourth example of the invention. FIG. 14 is a view illustrating the utilization condition of the distance measuring apparatus for dental implant insertion as illustrated in FIG. 13.

As compared to the third example, the distance measuring apparatus for dental implant insertion according to a fourth example has the same constitution excluding that the support frame 100 is made to be such that several points of the support frame 100 are hingedly connected to be bent. Accordingly, the description to the elements already described in the third example would be omitted.

As illustrated in FIGS. 13 and 14, the support frame 100 is provided with the guide frame 200 at its one side and the drilling guide frame 300 at its the other side. The support frame 100 is divided into several pieces, the respective ends of which are pivotably connected by means of the respective hinges.

More specifically, the support frame 100 is divided into three pieces, the ends of which are pivotably connected by means of a first hinge 110 and a second hinge 120, respectively. Therefore, the support frame 100 can be bent by the first and second hinges 110 and 120.

Hereinafter, description will be made to utilization of the distance measuring apparatus for dental implant insertion according to the present invention as stated above.

In order to determine a drilling point for insertion of a first implant 430, the guide frame 200 is positioned such that its inner curved surface is approximately close to the tooth 410, and by selecting any one of guide holes 210 which is positioned at a proper distance according to the positions of the drilling points, a drilling point can be determined. That is, the proper distance of any one of 3 mm, 3.5 mm, and 4 mm that are the distances L11, L12, and L13 from the inner curved surface of the guide frame 200 to the center of the guide holes 210 is selected and determined as a drilling point. In fact, since the proper distance is hardly measure in the portion adjacent to the tooth 410 due to sight hindrance of the tooth 410, the drilling point is determined by using the distance measuring apparatus for dental implant insertion according to the invention.

Meanwhile, since the graduated ruler 220 is formed on the outer edge of the guide frame 200, even though the drilling point has been determined by the guide hole 210, it is possible to check a precise position using the graduated ruler 220 in order to determine an error of the drilling point possibly caused from a shape of the distal surface of the tooth 410 or the affection by an alveolus and the like.

Further, as illustrated in FIG. 5, such measurement of the width of the alveolus using the graduated ruler 220 is very useful to select the implant 430 with proper diameter and serves as a guide for determining a drilling point at the center portion of the tooth-healing section.

After determining the drilling point for insertion of the first implant 430, a first implant insertion hole 420 is formed by drilling. Further, for determination of the drilling point for continuous insertion of the implants 430, the drilling guide frame 300 is used. As illustrated in FIGS. 10 to 12, the guide pin 600 is combined into the first drilling hole 310 and then it is inserted into the first implant insertion hole 420 determined so as to fix the drilling guide frame 300 to an alveolus or gum 400. The distance between the first and second drilling holes 310 and 320 is 7˜8 mm, which is the same as the general distance L30 of 7˜8 mm for continuous insertion of the implant 430 so that the second drilling hole 320 can be drilled without measuring a distance using a scale and to this end a second implant insertion hole 421 can be determined with ease.

Meanwhile, as illustrated in FIG. 9, the general implant drill 500 has a length of 8 mm (or 8.5 mm), 10 mm, or 12 mm (or 11.5 mm). Therefore, it is not required to measure the scales of the drill with the ruler one by one in an operation if using the stepped reference point 330 for easy measurement of the implant drill 500,

Furthermore, as illustrated in FIGS. 13 and 14, in case that the support frame 100 is divided into three pieces, the ends of the divided pieces are pivoted about the first and second hinges 110 and 120 so that the support frame can be inserted into the small and narrow mouth while being properly modified. Accordingly, it is possible to carry out more precise implant operation.

### EXAMPLE 5

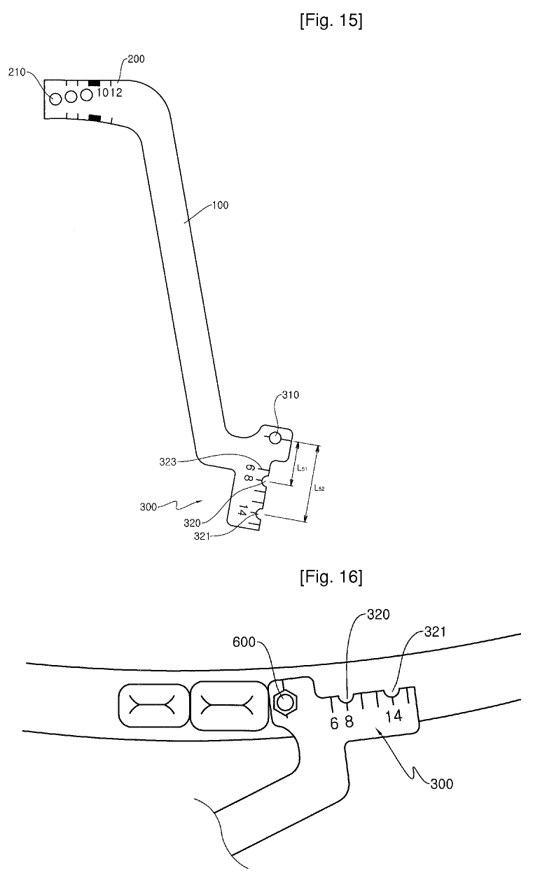

FIG. 15 is a view illustrating the constitution of a distance measuring apparatus for dental implant insertion according to a fifth example of the invention. FIG. 16 is a view illustrating the utilization condition of the distance measuring apparatus for dental implant insertion as illustrated in FIG. 15.

As illustrated in FIGS. 15 and 16, in the distance measuring apparatus for dental implant insertion according to the fifth example, the support frame 100 is provided with the guide frame 200 at its one side and a drilling guide frame 300 at the other side. The guide frame 200 has been described before so the detailed description thereof would be omitted.

The drilling guide frame 300 has a first drilling hole 310 at its one side. Further, a second drilling hole 320 and a third drilling hole 321 are formed spaced to the extent of 8 mm and 14 mm, respectively, from the first drilling hole 310 in a direction of the other side of the drilling guide frame 300. Herein, as illustrated in FIG. 15, among the first, second, and third drilling holes 310, 320, and 321 on a straight line, the first drilling hole 310 is a completely circular hole, and the second and third drilling holes 320 and 321 are semi-circular open holes. The drilling guide frame 300 has a shape of ‘L’ partially cut off, which is provided with the first drilling hole 310 at its one side and the semi-circular second and third drilling holes 320 and 321 at its inner surface of the other side. The distance L51 from the center of the first drilling hole 310 to that of the second drilling hole 320 is 8 mm, and the distance L52 between centers from the first to the third is 14 mm.

Furthermore, scales 323 are imprinted on the drilling guide frame 300 in a direction from the first drilling hole 310 toward the second and third drilling holes 320 and 321.

Hereinafter, description would be made to a procedure of determining the position of the continuous implants using the drilling guide frame.

As stated above, the first implant insertion hole 420 is formed using the guide frame 200. In case that an implant 430 is continuously inserted with reference to the first implant insertion hole 420, in advance, the first drilling hole 310 of the drilling guide frame 300 is matched with the first implant insertion hole 420. Then, under a state that the guide pin 600 is penetrated into the first drilling hole 310, the guide pin 600 is inserted and fixed into the first implant insertion hole 420. In this state, it is done to position the implant drill into the second drilling hole 320 and then to form a second implant insertion hole 421. Herein, the distance between the first and second implant insertion holes 420 and 421 is 8 mm.

If it is intended to form three implant insertion holes, it is done to remove the guide pin 600 from the first implant insertion hole 420 in advance, and then to insert and fix the guide pin 600 into the second implant insertion hole 421 with the guide pin 600 penetrating the first drilling hole 310, and to form the third implant insertion hole through the second drilling hole 320.

Meanwhile, as an example of an implant operation, as set forth before, although it is general to insert the implants 430 by a distance of 8 mm, the implants may be inserted by a distance of 14 mm. In this case, it is done to fix the guide pin 600 penetrating the first drilling hole 310 to the first implant insertion hole 420, and to form the second implant insertion hole through the third drilling hole 321. Herein, the distance between the first and second implant insertion holes is 14 mm.

The distances of 8 mm and 14 mm between the first and second drilling holes 310 and 320, and the first and third drilling holes 310 and 321, respectively, are the merely preferred examples. Therefore, the invention is not limited thereto and can be modified.

### EXAMPLE 6

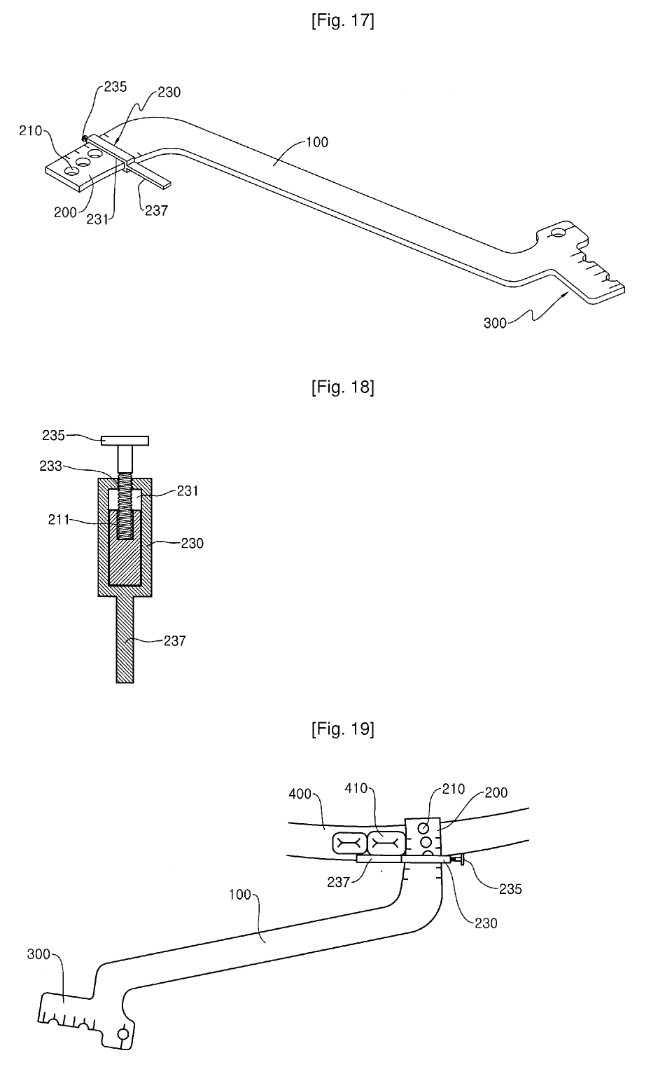

FIG. 17 is a view illustrating the constitution of a distance measuring apparatus for dental implant insertion according to a sixth example of the invention. FIG. 18 is a sectional view of the distance measuring apparatus for dental implant insertion as illustrated in FIG. 17. FIG. 19 is a view illustrating the utilization condition of the distance measuring apparatus for dental implant insertion as illustrated in FIG. 17.

The distance measuring apparatus for dental implant insertion according to the sixth example has the same constitution as that of the fifth example, excluding that a slider is further included therein to position the guide frame more stably while contacting the tooth.

As illustrated in FIGS. 17 to 19, the slider 230 is mounted to the guide frame so that it moves along the guide frame 200 in the lengthwise direction.

The slider 230 is provided with a slot 231, into which a leading end of the guide frame is inserted and which has the same area as a cross sectional area of s tailing end of the guide frame 200. Accordingly, under a state that the leading end of the guide frame is inserted into the slot 231, the slider 230 can be slidingly moved to the tailing end of the guide frame 200.

The slider 230 is provided at its upper portion with an internal screw hole 233, through which a bolt 235 is screwed so that the lower portion thereof moves toward the inside of the slot 231 to press against the guide frame 200.

Meanwhile, the guide frame 200 is provided at its outer surface with a groove 211.

Since the groove 211 is screwed with an end of the bolt 235, the slider 230 is not separated from the guide frame 200 as long as the bolt 235 is not released from the groove 211. Moreover, the slider 230 is provided with a support 237 at its lower portion, which is substantially perpendicular to the guide frame 200.

when making the inner curved surface of the guide frame 200 to contact the tooth 410 in order to determine a position of the implant insertion hole 420 through the guide frame with the slider 230 mounted thereto, the support 237 of the slider 230 and the inner curved surface of the guide frame 200 substantially perpendicular thereto are positioned contacting with the two sides of the tooth 410 so that the guide frame 200 can be positioned more stably. In short, contrary to the case that there is no slider 230, which means that upon determining a position of the implant insertion hole 420 it is somewhat unstable to determine the position because the guide frame 200 contacts only one side of the tooth 410, in the case that the slider 230 and the guide frame 200 contact the two sides of the tooth 410, the implant insertion hole 420 can be determined more stably.

Meanwhile, the slider 230 can be adjusted according to the size of the tooth 410 by moving it along the guide frame 200 in its lengthwise direction.

### INDUSTRIAL APPLICABILITY

The present invention relates to a distance measuring apparatus for dental implant insertion, and more particularly to a distance measuring apparatus for dental implant insertion comprising a support frame and a guide frame integrally formed to be bent from the upper part of the support frame and having a plurality of guide holes therein for determining drilling points.

1: A distance measuring apparatus for dental implant insertion comprising:
a support frame; and
a guide frame formed to be bent from one side of the support frame and having one or more guide holes for determining drilling points.

2: The distance measuring apparatus according to claim 1, wherein the guide hole is formed with its center positioning 3˜4.5 mm apart from an inner side surface of the guide frame.

3: The distance measuring apparatus according to claim 2, wherein the guide hole has a diameter of 1˜2.5 mm through which an implant drill passes.

4: The distance measuring apparatus according to claim 1, wherein the guide frame is provided with a graduated ruler at its outer side surface edge.

5: The distance measuring apparatus according to claim 1, wherein the support frame is provided with a drilling guide frame at the other side of the support frame and the drilling guide frame include a first drilling guide hole at the one side of the drilling guide frame and a second drilling hole spaced from the first drilling hole in a direction of the other side of the drilling guide frame.

6: The distance measuring apparatus according to claim 5, wherein the drilling guide frame is provided at its outer side with a reference point consisting of stepped stages, through which a length of the implant drill is measured.

7: The distance measuring apparatus according to claim 1, wherein the support frame is provided with one or more hinges at some parts of the support frame and the support frame is bent centering the hinge.

8: The distance measuring apparatus according to claim 5, wherein the support frame is provided with one or more hinges at some parts of the support frame and the support frame is bent at the middle of its length centering the hinge.

9: The distance measuring apparatus according to claim 5, wherein the drilling guide frame is provided with a third drilling hole on the line between the first drilling hole and the second drilling hole.

10: The distance measuring apparatus according to claim 9, wherein the first drilling hole is a circular hole, and the second and third drilling holes are semi-circular open holes formed on an edge of the drilling guide frame.

11: The distance measuring apparatus according to claim 9, wherein scales are formed from the first drilling hole to the third drilling hole.

12: The distance measuring apparatus according to claim 1, wherein the guide frame is provided with a slider moving in a lengthwise direction of the guide frame, and the slider has a slot through which the guide frame is inserted, and a bolt is fastened from an outer side of the slider to the inside of the slot in order to press the guide frame, and a support extends from the slider in a direction of the inner side of the guide frame.

13: The distance measuring apparatus according to claim 12, wherein the guide frame is provided with a groove along its lengthwise direction and the bolt is inserted into the groove to press and fix the guide frame.
